(19) United States
(12) Patent Application Publication
(10) Pub. No.: US 2004/0249631 A1
(43) Pub. Date: Dec. 9, 2004

(54) Methods and systems for credit card-size electronic dictionary configurable as a bookmark

(76) Inventor: Theresa Harris, Santa Monica, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/813,611

(22) Filed: Mar. 29, 2004

Related U.S. Application Data
(60) Provisional application No. 60/458,992, filed on Mar. 28, 2003.

(51) Int. Cl. G06F 17/28

(52) U.S. Cl. 704/7

(57) ABSTRACT

An electronic dictionary is configured to fit in a credit card holder. The electronic dictionary includes a flexible housing configured to accommodate the flexing of a credit card holder. The flexible housing has a length with substantially the same dimension as a credit card length and a height with substantially the same dimension as a credit card width. A flexible dictionary display is configured to display a plurality of words, and a dictionary keyboard is configured to receive user letter entries.

### PRIORITY CLAIM

This application claims the benefit under 35 U.S.C. 119(e) of U.S. Provisional Application No. 60/458,992, filed Mar. 28, 2003, the contents of which are incorporated herein in their entirety.

### BACKGROUND OF THE INVENTION

1. Field of the Invention

The present invention is related to electronic dictionaries, and in particular, to methods and systems for portable electronic dictionaries.

2. Description of the Related Art

Electronic dictionaries are commonly used to access word definitions. Some electronic dictionaries are hosted by general purpose desktop or portable computers, and some electronic dictionaries are dedicated portable dictionaries. The dedicated portable electronic dictionaries often include rigid LCD displays, which typically include inflexible glass. These LCD dictionary displays are often conventionally housed in a rigid, thick body to thereby protect the rigid and/or glass-based LCD displays from damage. Further, some electronic dictionaries have been configured for use as a combination electronic dictionary and bookmark, wherein the electronic dictionary is clipped to the book cover and an attached ribbon is used as a bookmark. However, many of these conventional “bookmark” electronic dictionary are typically relatively large in size and have a thick, rigid, hinged display screen that protrudes from the book when clipped to the book cover or pages.

### SUMMARY OF THE INVENTION

An example embodiment of the present invention provides an electronic dictionary that is the size and shape of a credit card in at least two dimensions, and so can advantageously be stored in the credit card compartment of a purse or wallet. Further, the electronic dictionary is optionally sufficiently flexible so that it can accommodate the normal flexing experienced by a wallet when carried and can further accommodate flexing when used as a bookmarker, such as in a paperback book. The electronic dictionary further optionally contains an expedited definition-locator feature. One embodiment enables the user to use the electronic dictionary as a bookmark either alone or in conjunction with a clip that firmly holds the electronic dictionary in place when clipped onto paper.

One embodiment is an electronic dictionary configured to fit in a credit card holder, including a flexible, unitary housing configured to accommodate the flexing of a credit card holder, the flexible housing having a length with substantially the same dimension as a credit card length, and a height with substantially the same dimension as a credit card width. The electronic dictionary further includes a flexible display configured to display a plurality of words and a flexible keyboard, the keyboard including keys corresponding to an alphabet.

Another embodiment provides an electronic dictionary configured to fit in a credit card holder, comprising: a flexible housing configured to accommodate the flexing of a credit card holder, the flexible housing having at least two dimensions that are substantially the same as that of a credit card; a display configured to display a plurality of words; and a keyboard configured to receive user letter entries.

Yet another embodiment provides an electronic dictionary configured to fit in a credit card holder, comprising: a dictionary housing configured to be inserted into a credit card holder, the dictionary housing having a length with substantially the same dimension as a credit card length and a height with substantially the same dimension as a credit card width; a display configured to display a plurality of words; and a program configured to look-up and present dictionary definitions as a user enters letters.

### BRIEF DESCRIPTION OF THE DRAWINGS

FIG. 1 illustrates a front view of an example embodiment of an electronic dictionary.

FIG. 2 illustrates a top plan view of the example electronic dictionary.

FIG. 3 illustrates a front view of an example electronic dictionary clip.

FIG. 4 illustrates a back view of the example electronic dictionary clip.

FIG. 5 illustrates a side view of the example electronic dictionary clip.

### DETAILED DESCRIPTION OF PREFERRED EMBODIMENTS

An example embodiment of the present invention provides a novel electronic dictionary that is substantially the size and shape of a credit card in at least two dimensions and so can advantageously be stored in the credit card compartment of a purse or wallet. Further, the electronic dictionary is optionally sufficiently flexible so that it can accommodate the normal flexing experienced by a wallet when carried and can further accommodate flexing when used as a bookmarker, such as in a paperback book. The electronic dictionary further optionally contains an expedited definition-locator feature. One embodiment enables the user to use the electronic dictionary as a bookmark either alone or in conjunction with a customized paper clip that firmly holds the electronic dictionary in place.

A preferred embodiment of the electronic dictionary is illustrated in the attached drawings and described as follows. With reference to FIG. 1, an electronic dictionary 100, including the housing or body 101, is made of a flexible material that conforms to the shape of a book when used as a bookmark or flexes as needed when stored in a wallet or credit card holder. In an example embodiment, the housing 101 is unitary in that is does not require hinges or the like to provide the desired flexibility, and instead relies on the flexibility of the housing materials and that of other components.

The preferred electronic dictionary dimensions are similar to that of a standard credit card. For example, the electronic dictionary can have the same or about the same height, width, and length of a credit card, though other dimensions can be used as well. For example, the electronic dictionary width can be twice that or half that of a credit card. In an example embodiment, the electronic dictionary has the following approximate dimensions: length 8.5 cm, height 5.4 cm, and width 2 cm, with a height to width ratio of approximately 2.7:1. This convenient shape and size of the electronic dictionary allows for storage in the credit card compartment of a wallet or purse. Further, as discussed below, an example embodiment of the electronic dictionary 100 has tapered edges that facilitate storage in a book as a bookmark or insertion into a purse or wallet credit card slot or holder. As will be discussed below, the dictionary 100 optionally can also be used with a lightweight and flexible “paper clip” that enables the user to clip the dictionary 100 to a page in a book or to a newspaper for easy reference.

The face of the example electronic dictionary 100 contains a display screen “window” 102 on the top one-third of the dictionary face and a keyboard on the lower two-thirds dictionary face. The display screen 102 in this example is substantially coplanar with the surface of the electronic dictionary body. The electronic dictionary body optionally has only six external sides or surfaces, as illustrated. In this example, the display screen 102 is large enough to display multiple words, including the word being looked up and at least a portion of the associated definition. For example, the display screen can provide at least 3 lines of 16 character text with the text and background in an easy to read color, black and white, or grey scale combination, such as a liquid crystal display or an organic light-emitting diode (OLED) display. However, smaller or larger displays can be used as well. For example, a 4 line by 40 character display can be used in another embodiment, and 2 lines by 16 character display can be used in still another embodiment. By way of example, OLED displays are prototyped by, manufactured by or available from General Electric, Kodak, Samsung, Digital Displays, and others.

By way of further example, the display 102 can be an active matrix display, configured as a flexible or bendable display, sometimes referred to as “electronic paper.” By way of example, and not limitation, such types of flexible displays can use or be based on polymer electronics, organic thin film transistors, and electronic ink technology and products from Gyricon, LLC, Polymer Vision, and the like. These display technologies can, for example, utilize two thin flexible plastic sheets with bichromal or multichromol beads, sometimes referred to as electronic ink, embedded in between the plastic. A given bead has a different color and charge on each quadrant, half or hemisphere of the bead. By way of still further example, a display substrate can be formed from a thin flexible plastic, such as an electronically inert polymer. Metal layers, including gold or other metals, are applied to the substrate using vacuum deposition or the like. Organic layers, including an insulating layer and a semi-conducting layer, are then applied and remain flexible. The organic layers are optionally supplied in solution form using spin-coating, dip-coating, printing, or the like. Photolithography is used to form structures on the metal layers. After applying the semi-conducting layer, electronic ink, in the form of bichromal or multichromol encapsulated charged particles or beads that can migrate under the influence of an electric field, can be laminated on top of the active matrix back plane. The active matrix display back plane includes a matrix of pixels. Each pixel includes a switch to actively control when each pixel is on and off. Thus, as described above, rather than including inflexible glass or inflexible circuit boards, the display optionally includes circuitry mounted to or formed on pliable plastic.

When an appropriate voltage is applied to the surface, the beads or other particles rotate to present an appropriate side (and hence color) to the viewer. This image will be constant until a new voltage pattern is applied, which erases the previous image and causes a new image to be formed. Advantageously, the power or battery usage is reduced using such techniques because of the image persistence even in the absence of an applied voltage.

The electronic dictionary also includes a keyboard 104. The keyboard keys in this example protrude above the front surface of the electronic dictionary 100, however in another embodiment the keys can be co-planar with the dictionary front surface. The keys are optionally fluorescent and glow in the dark.

In one embodiment, the keyboard is flexible, so that, in combination with the flexible display 102 and flexible body 101 described above, the dictionary 100 can optionally flex in one or more dimensions, such as across its entire length and/or width, or over most of its length and/or width. In an embodiment, the keyboard 104 utilizes a flexible conductive rubber keypad.

By way of illustration, in an embodiment, the keyboard 104 includes an external layer of a transparent, flexible polyester film wherein graphics, such as letters, can be silk screened on the film's inner side and viewed from the outer service. Optionally, the graphics can instead be printed, silk screened, or embossed on the outer surface of a non-transparent external layer. The flexible polyester layer is provided with conductive buttons and tracks printed or silk screened on its backside. When the buttons are depressed, they come into contact with a corresponding contact on a lower, flexible polyester layer.

In the illustrated example embodiment, the keyboard 104 has a bubble-button key for each letter of the alphabet and that are arranged in QWERTY or standard typewriter formation. Optionally, the letters can be arranged in an alphabetical order (A, B, C, D, etc.). In another embodiment, the display 102 and/or keyboard 104 are presented via a touch-screen so as to reduce moving parts and to make the dictionary 100 flatter. The housing 101 contains a power source, such as a thin battery, which can be non-rechargeable, a storage component that stores the dictionary in memory, and a computer chip, such as a central processing unit, that contains and executes the “search” or word look-up software program stored in readable memory, such as ROM (read only memory). The dictionary can be stored in non-removable readable memory and/or in removable cartridges, such as a memory stick, a smart media card, or a compact flash card.

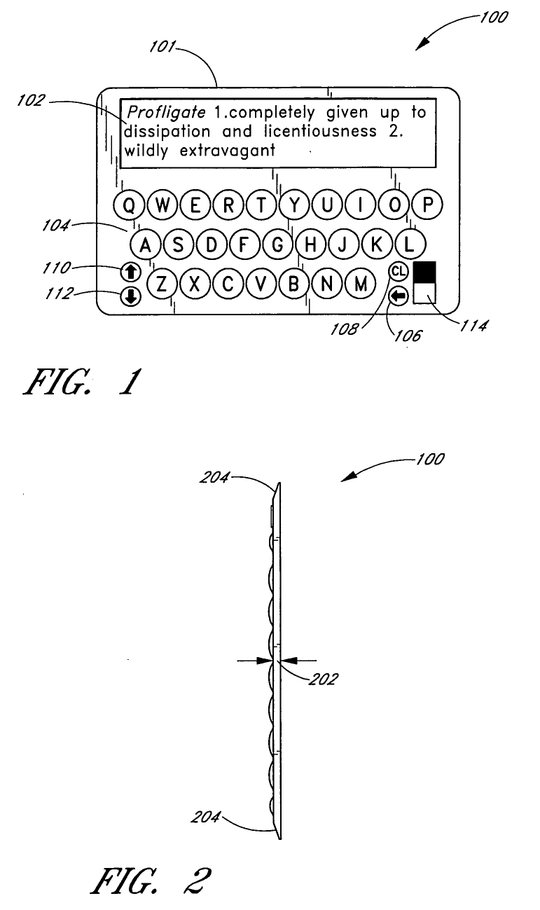

FIG. 2 illustrates a top plane view of the electronic dictionary 100. In this example, the dictionary 100 has a center width 202 having substantially the same measurement as the width of two standard credit cards, though other widths can be used as well. In this example, the dictionary has tapered edges 204 on both sides to ease insertion into a book as a bookmark and into a wallet credit card slot. The tapered edges 204 can further optionally include ridges for mating with paper clip apparatus described below.

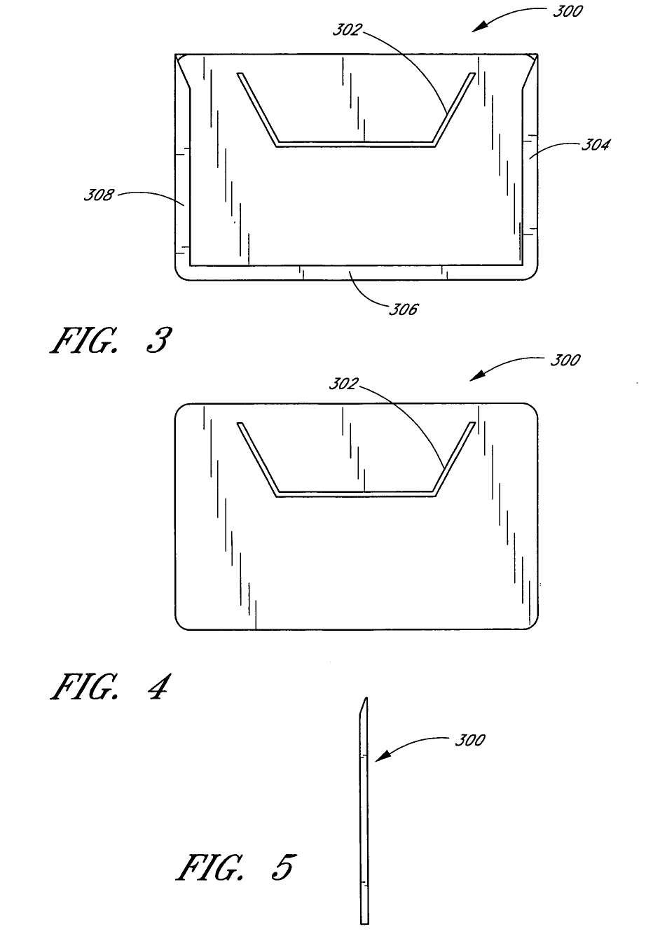

As discussed above and as illustrated in FIGS. 3-5, the dictionary 100 can optionally be used with a flexible “paper clip” apparatus 300 that enables the user to clip the electronic dictionary 100 to a page in a book or to a newspaper for easy reference. The clip apparatus 300 is made of a flexible material, such as vinyl or a pliable rubber or plastic, that substantially conforms to the shape of the book when used as a bookmark. Thus, normal flexing of the book, and in particular, a paperback book, will not break and/or dislodge the clip apparatus 300. In the illustrated embodiment, the clip apparatus 300 is made of a substantially transparent material. In the example embodiment, the electric dictionary is secured inside the clip apparatus 300 via ridges or tapered portions on the side of the electronic dictionary that fit into or mate with complimentary ridges or receiving portions 304, 306, 308 along the inside of the clip apparatus 300. The clip apparatus 300 further includes a clip 302 in a tensioned state, wherein the user slides a page or pages between the clip 302 and the remainder of the clip apparatus body and the tension holds the dictionary 100 in place.

FIG. 4 illustrates a view of the back of the electronic dictionary clip apparatus 300. FIG. 5 illustrates a side view of the electronic dictionary clip apparatus 100 shows the narrow sides of the clip that corresponds to the narrow, tapered and/or ridged edges of the electronic dictionary 100.

An example word look-up process is as follows. First, the user turns “on” the electric dictionary. Then, the user uses the letter keys on the keyboard to sequentially enter the letters of a word found in a book or newspaper. The “search” and locate feature matches the first letter typed-in to the first word in the section of the “dictionary” database containing said letter, then narrows the search by matching the second letter typed-in to the first word in the section of the dictionary containing such first and second letters, and so on until enough letters have been typed-in for the search feature to locate the desired word. Although the search feature optionally only searches the dictionary word, the words are optionally always shown on the display screen with their corresponding abridged dictionary definition. The user uses the “back arrow” key 106 to erase the most recent letter(s) that has been typed (at which time the search feature automatically returns to its former place in the “dictionary”). The “clear” key 108 enables the user to erase an entire word entry at any time during the process and start over. The user can search through various words (with definitions) by using a navigation device, such as the “up arrow” and “down arrow” keys 110, 112. By way of example, the display 102 illustrated in FIG. 1 is displaying a word the user has typed via the keyboard 104 and the corresponding abridged definitions thereof.

The electronic dictionary 100 described herein is commercially relevant in that it appeals to many sectors of the population. Interest in the dictionary can extend to academics, as well as to the proliferation of book clubs which provide an excellent environment for its usage because it enhances the book-lovers reading experience. For the same reason, avid newspaper readers will find the electronic dictionary to be a convenient, useful resource. The electronic dictionary would appeal to the education-minded parent who would purchase the electronic dictionary for his/her student-age child(ren) to enable the student to broaden their lexicon and thereby attain higher scores on high school and/or college entrance exams. Indeed, mastery of the English language through the understanding and usage of vocabulary has unlimited benefits in today's modern society.

Thus, as described above, the dictionary described herein provides one or more of the following optional advantages and features:

1. The electronic dictionary optionally does not require the use of an “enter” key; the electronic dictionary optionally takes only two steps for usage, turning the electronic dictionary “on,” and typing in letters of a word.

2. The electronic dictionary is not bulky and stores easily and conveniently in a purse or wallet.

3. The electronic dictionary is flexible and bendable, and therefore suitable for use as a bookmark and for storage in a wallet or purse.

4. The electronic dictionary optionally replaces the standard paper bookmark; the electronic dictionary is not an additional “gadget.”

5. The electronic dictionary has florescent keys that glow in the dark.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. An electronic dictionary configured to fit in a credit card holder, comprising:
a flexible, unitary housing configured to accommodate the flexing of a credit card holder, the flexible housing having:
a length with substantially the same dimension as a credit card length;
a height with substantially the same dimension as a credit card width;
a flexible display configured to display a plurality of words; and
a flexible keyboard, the keyboard including keys corresponding to an alphabet.

2. The electronic dictionary as defined in claim 1, wherein the electronic dictionary has a height to width ratio of approximately 2.7:1.

3. The electronic dictionary as defined in claim 1, wherein the electronic dictionary has at least a first tapered edge.

4. The electronic dictionary as defined in claim 1, wherein the flexible display is an organic light emitting diode display.

5. The electronic dictionary as defined in claim 1, wherein the flexible display is a liquid crystal display.

6. The electronic dictionary as defined in claim 1, wherein the flexible display includes chargeable spheres having at least two colors.

7. The electronic dictionary as defined in claim 1, wherein the flexible display is an organic led emitting diode display.

8. The electronic dictionary as defined in claim 1, wherein the flexible display includes a flexible substrate.

9. The electronic dictionary as defined in claim 1, further comprising a removable clip configured to clip the electronic dictionary to at least a first page.

10. The electronic dictionary as defined in claim 1, wherein the flexible keyboard has keys that glow in the dark.

11. The electronic dictionary as defined in claim 1, wherein the flexible keyboard does not include an entry key.

12. The electronic dictionary as defined in claim 1, wherein abridged definitions are presented by the electronic dictionary as a user keys in letters.

13. An electronic dictionary configured to fit in a credit card holder, comprising:
a flexible housing configured to accommodate the flexing of a credit card holder, the flexible housing having at least two dimensions that are substantially the same as that of a credit card;
a display configured to display a plurality of words; and
a keyboard configured to receive user letter entries.

14. The electronic dictionary as defined in claim 13, wherein the electronic dictionary has a height to width ratio of approximately 2.7:1.

15. The electronic dictionary as defined in claim 13, wherein the electronic dictionary has a unitary housing and wherein the display is substantially coplanar with the unitary housing surface.

16. The electronic dictionary as defined in claim 13, wherein the electronic dictionary flexes along both its length and height.

17. The electronic dictionary as defined in claim 13, wherein the electronic dictionary has at least a first tapered edge to ease the insertion of the electronic dictionary into at least one of a holder, a wallet credit card slot, and a book.

18. The electronic dictionary as defined in claim 13, wherein the display is a glassless display.

19. The electronic dictionary as defined in claim 13, wherein the display persistently displays an image after an applied voltage is removed.

20. The electronic dictionary as defined in claim 13, wherein the display includes a flexible substrate.

21. The electronic dictionary as defined in claim 13, further comprising a removable clip apparatus configured to fit over at least a portion of the flexible housing.

22. The electronic dictionary as defined in claim 13, wherein the keyboard does not include an entry key.

23. The electronic dictionary as defined in claim 13, wherein definitions are presented by the electronic dictionary as a user keys in letters.

24. The electronic dictionary as defined in claim 13, wherein the electronic dictionary has a width substantially twice that of a credit card.

25. The electronic dictionary as defined in claim 13, wherein the keyboard is coplanar with a housing surface.

26. The electronic dictionary as defined in claim 13, wherein the keyboard includes a touch screen.

27. The electronic dictionary as defined in claim 13, wherein the keyboard further comprises navigation keys.

28. The electronic dictionary as defined in claim 13, wherein the electronic dictionary has only six external sides.

29. An electronic dictionary configured to fit in a credit card holder, comprising:
a dictionary housing configured to be inserted into a credit card holder, the dictionary housing having:
a length with substantially the same dimension as a credit card length;
a height with substantially the same dimension as a credit card width;
a display configured to display a plurality of words; and
a program configured to look-up and present dictionary definitions as a user enters letters.

30. The electronic dictionary as defined in claim 29, further comprising a user removable paper clip.

31. The electronic dictionary as defined in claim 29, wherein the display includes at least two lines.

32. The electronic dictionary as defined in claim 29, wherein the display includes chargeable spheres having at least two colors.

33. The electronic dictionary as defined in claim 29, wherein the display is flexible.

34. The electronic dictionary as defined in claim 29, wherein the housing is flexible.

35. The electronic dictionary as defined in claim 29, wherein the housing is a unitary housing.

36. The electronic dictionary as defined in claim 29, wherein the credit card holder is a wallet credit card holder.

37. The electronic dictionary as defined in claim 29, wherein the dictionary definitions are abridged.

38. The electronic dictionary as defined in claim 29, wherein the housing length is about 8.5 cm and the housing height is about 5.4 cm.
